(19) United States
(12) Patent Application Publication
(10) Pub. No.: US 2021/0022551 A1
(43) Pub. Date: Jan. 28, 2021

(54) Charcoal Pyramid

(71) Applicant: Maurice Sauls, Dallas, TX (US)

(72) Inventor: Maurice Sauls, Dallas, TX (US)

(21) Appl. No.: 16/523,362

(22) Filed: Jul. 26, 2019

(51) Int. Cl. A47J 37/07; B65D 5/42; B65D 5/46; B65D 5/20; C10L 11/06

(52) U.S. Cl. CPC A47J 37/0786; B65D 5/4295; C10L 5/361; B65D 5/2042; C10L 11/06; B65D 5/46

(57) ABSTRACT

A combustible product made of cardboard and compositions efficiently and conveniently supplies heat, such as for outdoor cooking. The product includes combustible material contained in a substantially four sided pyramid exterior, a substantially four sided pyramid interior space, a large closed diameter at the base of the pyramid and a small closed diameter at the top of the pyramid creating a highly conducive form for the combustible material contained in the product package, to ignite quickly and sustain an efficient and long lasting burn. The product package will come in several sizes to meet the consumers needs. The sizes will consist of extra large, large, medium, small and extra small.

### FIELD

Convenient combustible product, made of cardboard, and packaged designed as a four sided pyramid, for efficient burning of combustible material. The charcoal pyramid is adapted to be a complete, per-manufactured package burned in a barbecue grill as fuel. The design shapes the combustible material in a pyramid design and because flames burns upward, this allows the base of the pyramid to stay intact, and hold the combustible material in the shape of a pyramid long after the sides have burned away and will remain that way until you spread them. This maximize the igniting of the combustible material, while minimizing the waste. The pyramids come in various sizes, XL, large, medium, small and XS, in order to eliminate the guess in trying to determine how much charcoal or combustible material to use.

### BACKGROUND

Since the discovery of fire, mankind has grilled food over an open flame. It was the first means of cooking and thanks to the invention of the Weber Grill and various other grills, the art of grilling has remained still a popular way to cook food. However, we have looked for ways to improve the grilling process, because it can be a messy bothersome task. This is due to the handling of the combustible material, that is normally contained in a 10 to 20 lb bags. The consumer would have to lift the bag, pour the combustible material into the grill, while guessing on the amount needed, then attempt to arrange them in a pyramid form.

There are a few things wrong with this process. First, there is the handling and lifting of a heavy and often dirty bag and second, is the guessing of how much charcoal, or combustible material to use; which could lead to a waste or not enough charcoal used. Third, the classic pile of charcoal, in the grill, burns slowly and inefficiently and if you build them in a pyramid, then you will have to deal with the further mess of your hands.

Some have taken to the use of a charcoal chimney, that holds the charcoal until they are all burning and then subsequently poured into the grill, which requires special gloves, goggles and precaution but also, is just another step in the grilling process that is time consuming and inconvenient.

### SUMMARY

Accordingly, it is an object of the present invention to provide a convenient package and/or assembly that is designed to be ready to use and convenient to use for a consumer. Further, the package is designed maximize and enhance the use of the combustible material and minimize the waste of such material.

This is a combustible material product defining a substantially four sided cardboard pyramid shaped exterior, that is designed to keep the combustible material in its interior intact pyramid form. All four sides of the pyramid has three vent holes; one at the top, middle and bottom. This allows you to apply accelerant proportionately and evenly to the combustible material contained within the interior. The vents also allows airflow, to ensure fast and sustained igniting of the combustible material contained inside.

The base of the pyramid stays intact, long after the sides have burnt away, due to the flames raging upward. This allows the base of the pyramid to maintain the validity of the combustible material in pyramid form, until the combustible material is spread by the consumer.

The convenience of the invention is that you only need to apply the accelerant, placed the pyramid in the grill and light it. You never have to touch the combustible material inside or lift any heavy containers and the pyramid comes with an easy carry handle that is also combustible. The convenience of the invention is further expressed by coming in various sizes; such as: X-Large, Large, Medium, Small and X-Small. This will eliminate the guesswork of trying to decide how much combustible material to use. Each size will come with a suggestion of best usage.

### BRIEF DESCRIPTIONS OF THE DRAWINGS

FIG. 1 is perspective view of the open design of an extra small pyramid prior to assembly.

FIG. 2 is perspective view of the open design of a small pyramid prior to assembly.

FIG. 3 is perspective view of the open design of a medium pyramid prior to assembly.

FIG. 4 is perspective view of the open design of a large pyramid prior to assembly.

FIG. 5 is perspective view of the open design of an extra large pyramid prior to assembly.

FIG. 6 is perspective view of a transparent pyramid design to show how the combustible material will pack in a pyramid form after assembly.

FIG. 7 is perspective view of the fully assembled pyramid design complete with the carrying handles and the indications on where and how to apply the accelerant to the vent holes.

### DETAILED DESCRIPTION

The present invention is directed to a product and package of combustible material that is easily stored and handled for use with cooking. The pyramid shape has predetermine sizes for convenience and practicality. The geometry of the pyramid itself is engineered for an efficient and effective burn of the combustible material.

Of course, other hybrids and combinations of features of combustible products and packaging will be evident to those of skill in the art given the teachings herein. What will be feature is the simplicity of the product while it will also improves the effectiveness of cooking with combustible material.

In general terms, the product simplifies and improve the preparation of fuel for burning in several ways. The product will be pre-measured in common units that are self contained. The product is pre-shaped and does not require manual arrangement or the use of additional tools to facilitate heating. The pyramid shape of the product allows the combustible material to be pre-shaped in pyramid form, which is recommended by experts, is the best way to get the most effective, while enhancing the heat, use of combustible material when grilling.

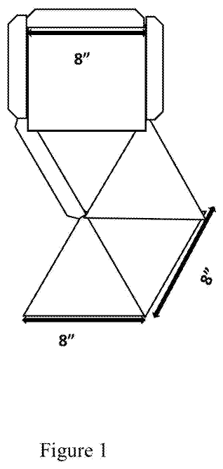

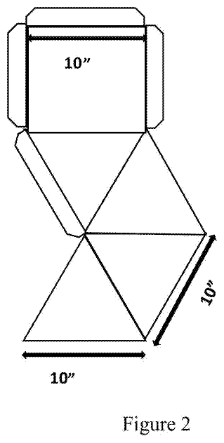

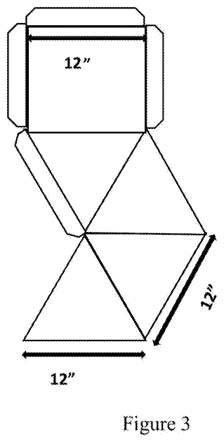

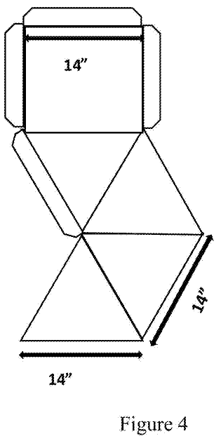

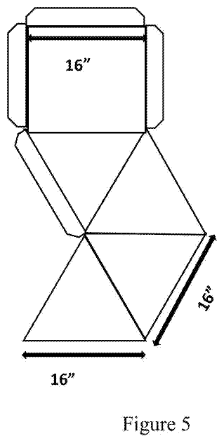

FIGS. 1-5 illustrate examples to the basic designs of the containers in various sizes prior to the combustible material being added. It illustrates that all fours sides, of each size, are perfectly equal, with the base equaling the largest diameter of the pyramid. This simple design allows the pyramid to be small in diameter at the top and large in diameter at the bottom, forming a perfect seal at both top and bottom.

The present invention is not limited by the geometry of the particular pyramid shape shown in the figures. However, when describing the assembly of individual combustible pieces, the sides will be referred to as triangle walls and the bottom of the combustible pieces will be referred to as the base.

The diagrams illustrate four equal triangle walls with a base that is perfectly squared to equal the bottom diameter of the pyramid. Each triangle wall will have three equally placed vents that will allow the consumer to add accelerant to the combustible material inside and to help with airflow, so that the combustible material can burn with an even flow. At the top, approximately and inch down and centered on the smaller diameter of the triangle walls, will be the first vent, approximately half an inch in diameter. The combustible handles will also be strung through the first vent. The second vent will be approximately halfway down the triangle walls and length will horizontally extend, on both sides, approximately an inch away from the triangle walls edge and will be approximately an inch in width. The third vent will be positioned approximately two inches from the bottom of the triangle walls with a horizontal length approximately an inch way from the triangle walls edge, on both sides and approximately an inch in width. There are also flaps to enclose the pyramid, so that it may contain the combustible material when added. There is one flap, which is positioned on the opened side of the last triangle wall. There are three flaps positioned on the opened three sides of the base. When the four triangle walls are folded the flap on the last triangle wall will seal to form the four pyramid walls. The base of the pyramid is left open until the combustible material is added.

The combustible material may include one or more or mixtures of different combustible materials including charcoal, coal, wood or other known combustible materials for cooking. Particularly in the example of a pyramid used in connection with grilling, there may be a desirable combination of charcoal and wood products to obtain a desired taste. The combustible material is fed through the large diameter bottom of the pyramid and the base is then folded over the bottom of the pyramid and the open sides with the flaps are sealed to the other three triangle walls. This provides structural stability as well as improved and extended burning in which the relatively less massive sections burn through quickly after igniting leaving the relatively more massive portions to burn more slowly, thereby providing a sustained heat source for cooking.

The flaps are secured through the use of adhesive. Preferably, the adhesive is comprised of a composition designed to itself burn without omitting toxic fumes.

The outside of the packaging material may be used for printing and graphics for marketing and consumer purchase. Preferably, all packaging material is made from a combustible material, which is cardboard, and will be simple to print on.

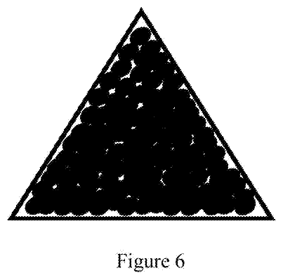

FIG. 6 illustrates a transparent view, after the pyramid has been assembled and how the combustible material will settle in the packaging by forming a pyramid shape, which has been suggested to be a favorable form to efficiently heat the combustible material. It shows the loose combustible material filling the space between the interior of the package, wherein the combustible material is selected from the group consisting of charcoal and coal. The loose combustible material filling the interior of the package; wherein the package further comprises cardboard forming the pyramid shaped exterior and interior surfaces; and wherein in a cross sectional width of the package with combustible material inside.

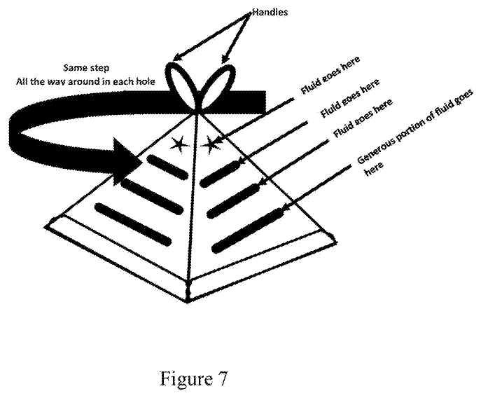

FIG. 7 illustrates the assembled package product once the combustible material is contained and the package is sealed. It shows that the package is completely sealed at the top, by the folding of the triangle walls and the sealing of the flap, on the last triangle wall, with combustible non-toxic adhesive, and the base and its flaps have sealed the bottom of the product package, which provides structural stability as well as improved and extended burning in which the less massive sections burn through more quickly after igniting leaving the more massive portion to burn more slowly, thereby providing a sustained heat source for cooking. Also, due to the fact that flames burn upward and the massive section burning more slowly, the base to the product package maintains its structure a longer period of time, there in fact, keeping the combustible material piled in pyramid form.

It also illustrate the vents and how they are strategically placed on all the triangle walls, so that accelerant can be applied, as an arrows demonstrates to apply accelerant to each and every vent and a larger curved arrow instructs to repeat the steps to all four sides of the product package, with a generous portion suggested to be applied to the larger more massive section, since it will burn longer and slower.

What the illustration also points out are the easy carry handles that will be attached to the product package, so that the consumer will have an easy way to carry the package from purchase and to their gill, when they decide to use the product. The handle will also be made of some type of combustible material.

1. A combustible package comprising:
a four walls pyramid shaped, combustible package closed in top of the package and closed in base of the package, wherein the base of the package is relatively larger, in diameter, than at the top of the package:
the package having a substantially pyramid shape and defining a space there-between;
loose combustible material filling the space between the interior of the package. Wherein the combustible material is selected from the group consisting of charcoal and coal;
and wherein in a cross sectional width of the package with combustible material inside, the width at the top of the pyramid is less than the width at the base of the pyramid, permitting the combustible material to pile in pyramid form in the interior of the package assure a longer and efficient burn.

2. A combustible package comprising:
a four walls pyramid shaped, combustible package closed in top of the package and closed in base of the package, wherein the base of the package is relatively larger than the diameter at the top of the package:
the package having a substantially pyramid shape and defining a space there-between;
loose combustible material filling the space between the interior of the package; wherein the package further comprises cardboard forming the four walls pyramid shaped exterior and interior surfaces; and wherein in a cross sectional width of the package with combustible material inside; the width at the top of the pyramid is less than the width at the base of the pyramid, permitting the combustible material to pile in pyramid form in the interior of the package assure a longer and efficient burn.

3. A combustible package comprising:
a four walls pyramid shaped, combustible package closed in top of the package and closed in base of the package, wherein the base of the package is relatively larger than the diameter at the top of the package:
the package having a substantially pyramid shape and defining a space there-between;
charcoal briquettes or lumps or any other coal and/or combustible material filling the space between the interior of the package; and wherein in a cross sectional width of the package with combustible material inside; the width at the top of the pyramid is less than the width at the base of the pyramid, permitting the combustible material to pile in pyramid form in the interior of the package assure a longer and efficient burn.

4. A combustible package comprising:
a four walls pyramid shaped, combustible package closed in top of the package and closed in base of the package, wherein the base of the package is relatively larger than the diameter at the top of the package:
the package having a substantially pyramid shape and defining a space there-between;
loose combustible material filling the space between the interior of the package; wherein the package further comprises various sizes of the four walls pyramid shaped exterior and interior surfaces; and wherein in a cross sectional width of the package with combustible material inside varies with the size of the package; the width at the top of the pyramid is less than the width at the base of the pyramid, permitting the combustible material to pile in pyramid form in the interior of the package assure a longer and efficient burn; wherein the various sizes allows consumers to choose the correct size for their grilling needs.

5. A combustible package comprising:
a four walls pyramid shaped, combustible package closed in top of the package and closed in base of the package, wherein the base of the package is relatively larger than the diameter at the top of the package:
the package having a substantially pyramid shape and defining a space there-between;
loose combustible material filling the space between the interior of the package; comprises cardboard forming the four walls pyramid shaped exterior and interior surfaces; wherein the package further comprises easy carry combustible handles attached to the package; and wherein in a cross sectional width of the package with combustible material inside; the handles will make it convenient for the consumer to carry the product package and the placement of the product package in the grill; the width at the top of the pyramid is less than the width at the base of the pyramid, permitting the combustible material to pile in pyramid form in the interior of the package assure a longer and efficient burn.

6. A combustible package comprising:
a four walls pyramid shaped, combustible package closed in top of the package and closed in base of the package, wherein the base of the package is relatively larger than the diameter at the top of the package:
the package having a substantially pyramid shape and defining a space there-between;
loose combustible material filling the space between the interior of the package; comprises cardboard forming the four walls pyramid shaped exterior and interior surfaces; wherein the package further comprises easy carry combustible handles attached to the package; wherein the package further comprises convenient vent holes on all four walls of the product package, to allow the adding of accelerant and to provide airflow; and wherein in a cross sectional width of the package with combustible material inside; the handles will make it convenient for the consumer to carry the product package and place the product package in the grill; the width at the top of the pyramid is less than the width at the base of the pyramid, permitting the combustible material to pile in pyramid form in the interior of the package assure a longer and efficient burn.
